(19) United States
(12) Patent Application Publication
(10) Pub. No.: US 2024/0414680 A1
(43) Pub. Date: Dec. 12, 2024

(54) UL-TDOA AND DL-TDOA FOR ACCURACY ENHANCEMENT

(71) Applicant: MEDIATEK INC., Hsinchu City (TW)

(72) Inventor: Chiao-Yao CHUANG, Hsinchu City (TW)

(21) Appl. No.: 18/262,790

(22) PCT Filed: Jan. 26, 2022
(86) PCT No.: PCT/CN2022/074022

§ 371 Date: Jul. 25, 2023

Related U.S. Application Data
(60) Provisional application No. 63/169,264, filed on Apr. 1, 2021.
(60) Provisional application No. 63/166,287, filed on Mar. 26, 2021.
(60) Provisional application No. 63/200,574, filed on Mar. 16, 2021.
(60) Provisional application No. 63/160,959, filed on Mar. 15, 2021.
(60) Provisional application No. 63/141,522, filed on Jan. 26, 2021.

(51) Int. Cl. H04W 64/00; H04L 5/00; H04W 56/00

(52) U.S. Cl. CPC H04W 64/00; H04L 5/0051; H04W 56/0015

(57) ABSTRACT

In an aspect of the disclosure, a method, a computer-readable medium, and an apparatus are provided. The apparatus may be a UE. The UE receives, from a serving base station of the UE, an SRS configuration. The UE transmits a first SRS and a second SRS in accordance with the SRS configuration. The UE sends, to a network, (a) an indication of a respective TX RF chain of the UE associated with each of the first SRS and the second SRS or (b) an indication of a timing delay error level of the respective TX RF chain associated with each of the first SRS and the second SRS.

### CROSS-REFERENCE TO RELATED APPLICATIONS

This application claims the benefits of U.S. Provisional Application Ser. No. 63/141,522, entitled “PROCEDURE TO ASSIST NETWORK FOR TRANSMISSION TIMING CALIBRATION FOR POSITIONING ACCURACY ENHANCEMENT” and filed on Jan. 26, 2021; U.S. Provisional Application Ser. No. 63/160,959, entitled “FURTHER ACCURACY ENHANCEMENT FOR DL+UL POSITIONING TECHNIQUES” and filed on Mar. 15, 2021; U.S. Provisional Application Ser. No. 63/200,574, entitled “FURTHER ACCURACY ENHANCEMENT FOR DL POSITIONING TECHNIQUES” and filed on Mar. 16, 2021; U.S. Provisional Application Ser. No. 63/166,287, entitled “FURTHER ACCURACY ENHANCEMENT FOR UL POSITIONING TECHNIQUES” and filed on Mar. 26, 2021; and U.S. Provisional Application Ser. No. 63/169,264, entitled “FURTHER ACCURACY ENHANCEMENT FOR DL POSITIONING TECHNIQUES” and filed on Apr. 1, 2021; all of which are expressly incorporated by reference herein in their entirety.

### TECHNICAL FIELD

The present disclosure relates generally to communication systems, and more particularly, to techniques of positioning a user equipment (UE).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. In certain configurations, the apparatus may implement a location management function. The location management function receives a first uplink relative time of arrival (UL-RTOA) of a first SRS arriving at first transmission and reception point (TRP). The location management function receives a second UL-RTOA of a second SRS arriving at a second TRP. The location management function receives (a) an indication of a respective transmission (TX) radio frequency (RF) chain of a UE associated with each of the first SRS and the second SRS or (b) an indication of a respective timing delay error level of the respective TX RF chain associated with each of the first SRS and the second SRS. The location management function calculates a UL-RSTD that is a difference between the first UL-RTOA and the second UL-RTOA based on the indication of the respective TX RF chain or the indication of the respective timing delay error level.

In certain configurations, the location management function receives a DL-RSTD measured at a UE with respect to a first TRP and a second TRP. The location management function receives an identifier of the UE from a base station. The location management function determines that the UE is a PRU based on the identifier. The location management function receives position coordinates of the PRU from the base station. The location management function determines a downlink RTD based on the DL-RSTD received from the PRU and the coordinates of the PRU. The downlink RTD is associated with a baseband symbol boundary difference in transmission between the first TRP and the second TRP and a difference between a transmission group delay at the first TRP and a transmission group delay at the second TRP.

In certain configurations, the location management function determines a UL-RSTD that is a difference between a first UL-RTOA of an SRS arriving at a first TRP and a second UL-RTOA of the SRS arriving at a second TRP. The location management function receives an identifier of the UE from a base station. The location management function determines that the UE is a PRU based on the identifier. The location management function receives position coordinates of the PRU from the base station. The location management function determines an uplink RTD based on the UL-RSTD received from the PRU and the coordinates of the PRU. The uplink RTD is associated with a baseband symbol boundary difference in reception between the first TRP and the second TRP and a difference between a reception group delay at the first TRP and a reception group delay at the second TRP.

In certain configurations, the location management function receives, from a UE, a DL-RSTD with respect to a first TRP and the second TRP. The location management function receives (a) a first delay sum of a transmission group delay and a reception group delay at a first pair of TX and RX RF chains of the UE and a second delay sum of a transmission group delay and a reception group delay at a second pair of TX and RX RF chains of the UE or (b) a difference between the first delay sum and the second delay sum. The UE receives, through a higher layer singling, an indication of a first association of the first delay sum with the first pair of TX and RX RF chains and an indication of a second association of the second delay sum with the second pair of TX and RX RF chains.

In another aspect of the disclosure, a method, a computer-readable medium, and an apparatus are provided. The apparatus may be a UE. The UE receives, from a serving base station of the UE, an SRS configuration. The UE transmits a first SRS and a second SRS in accordance with the SRS configuration. The UE sends, to a network, (a) an indication of a respective TX RF chain of the UE associated with each of the first SRS and the second SRS or (b) an indication of a timing delay error level of the respective TX RF chain associated with each of the first SRS and the second SRS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications among TRPs and UEs.

FIG. 8 is a diagram illustrating uplink transmissions from a UE to TRPs.

FIG. 9 is a diagram illustrating downlink transmission from TRPs to a UE.

FIG. 10 is a flow chart of a method (process) for processing location data.

FIG. 11 is a flow chart of a method (process) for sending location data.

FIG. 12 is a flow chart of a method (process) for processing location data in connection with a DL-RSTD.

FIG. 13 is a flow chart of a method (process) for processing location data in connection with a UL-RSTD.

FIG. 14 is a flow chart of another method (process) for processing location data in connection with a DL-RSTD.

FIG. 15 is a diagram illustrating an example of a hardware implementation for an apparatus employing a processing system.

FIG. 16 is a diagram illustrating an example of a hardware implementation for another apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

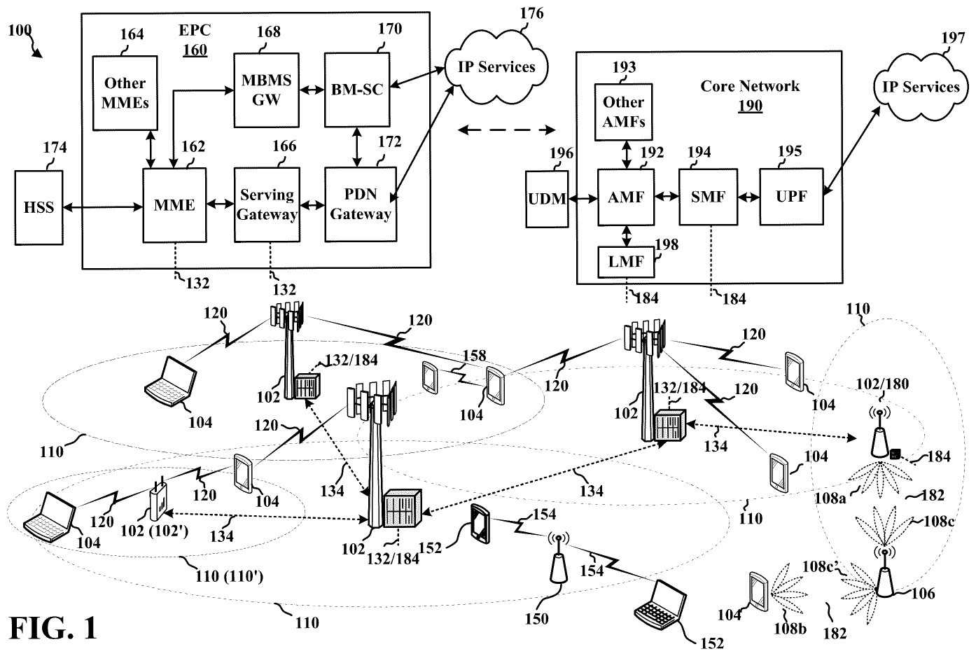

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per component carrier allocated in a carrier aggregation of up to a total of Y*x MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ. WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHZ to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

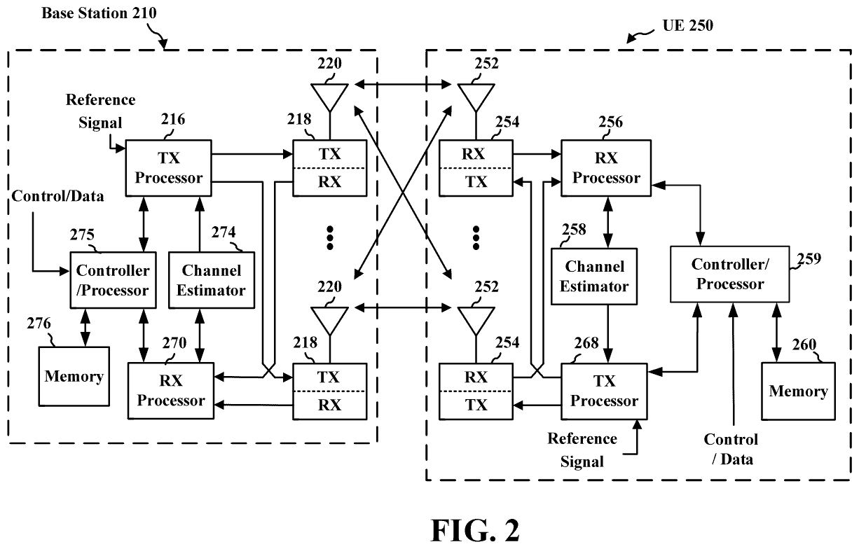

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

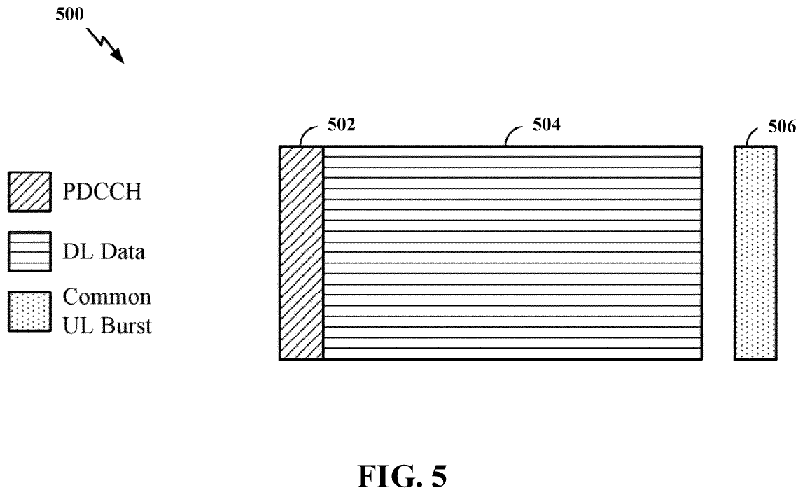

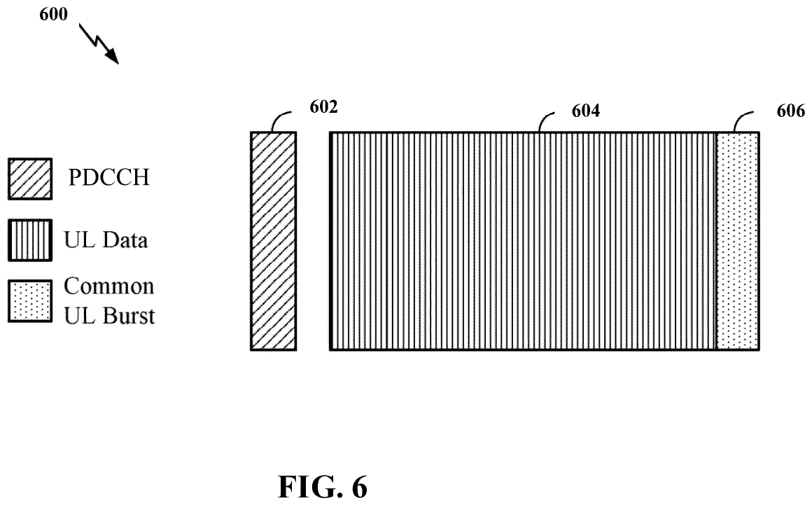

A single component carrier bandwidth of 100 MHz may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

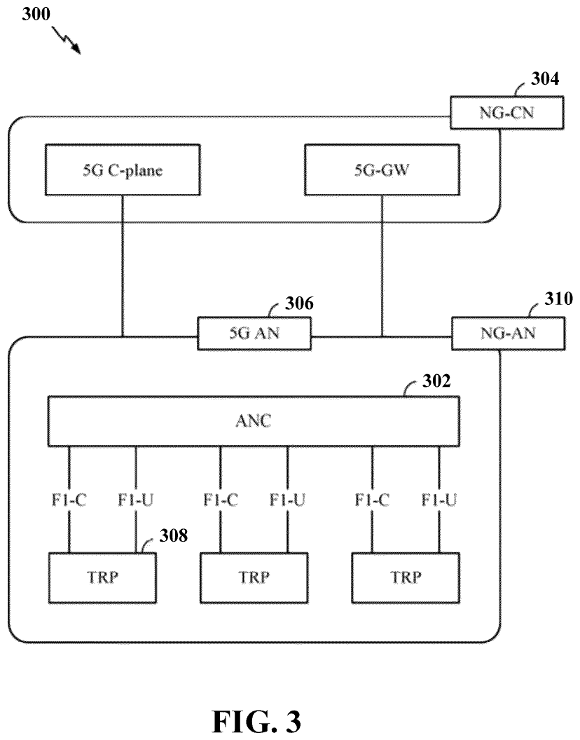

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

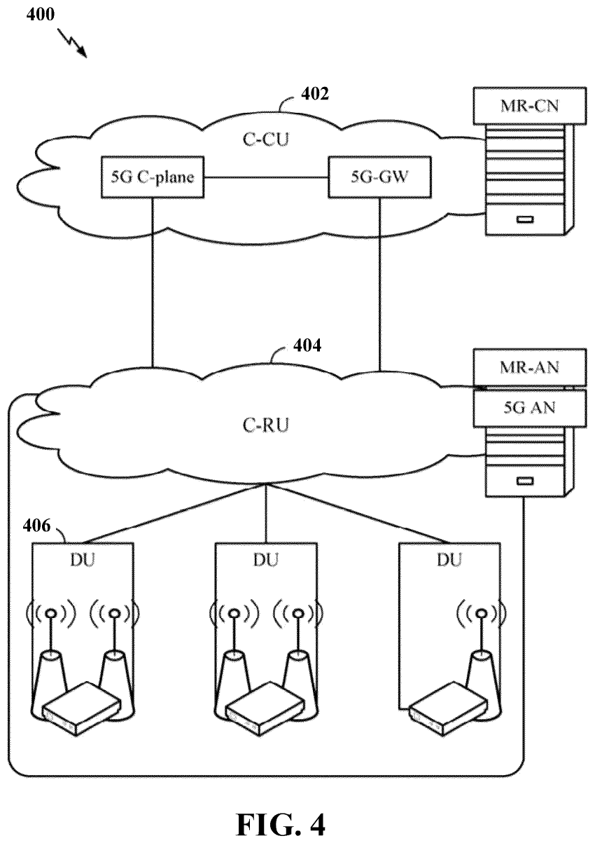

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

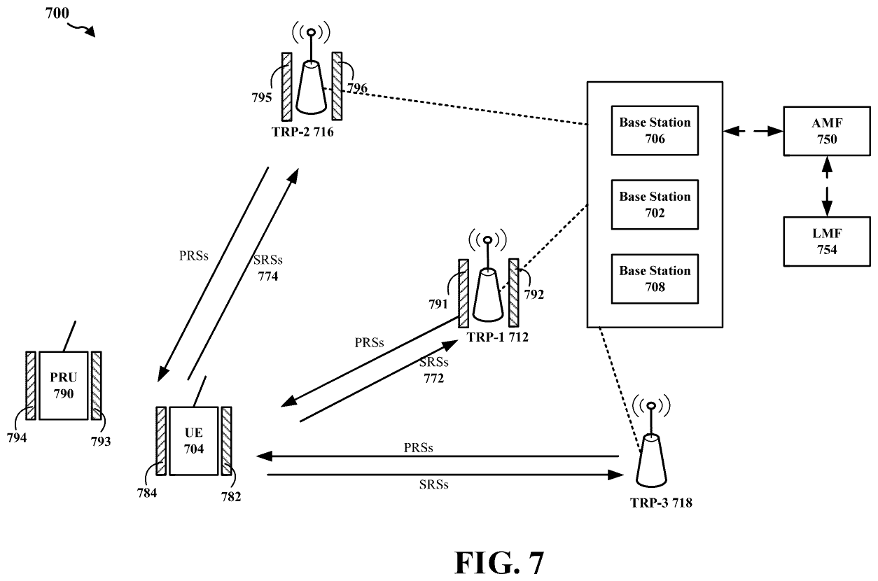

FIG. 7 is a diagram 700 illustrating communications among transmission and reception points (TRPs) and UEs. In this example, a UE 704, optionally a PRU 790 (described infra), may be in communication with a TRP 712, a TRP 716, and a TRP 718. Further, each of the TRP 712, the TRP 716, and the TRP 718 may be operated by one of a base station 702, a base station 706, and a base station 788. The UE 704 has an antenna-panel-I 782 and an antenna-panel-II 784. The TRP-1 712 has an antenna-panel-A 791 and an antenna-panel-B 792. The TRP-2 716 has an antenna-panel-C 795 and an antenna-panel-D 796.

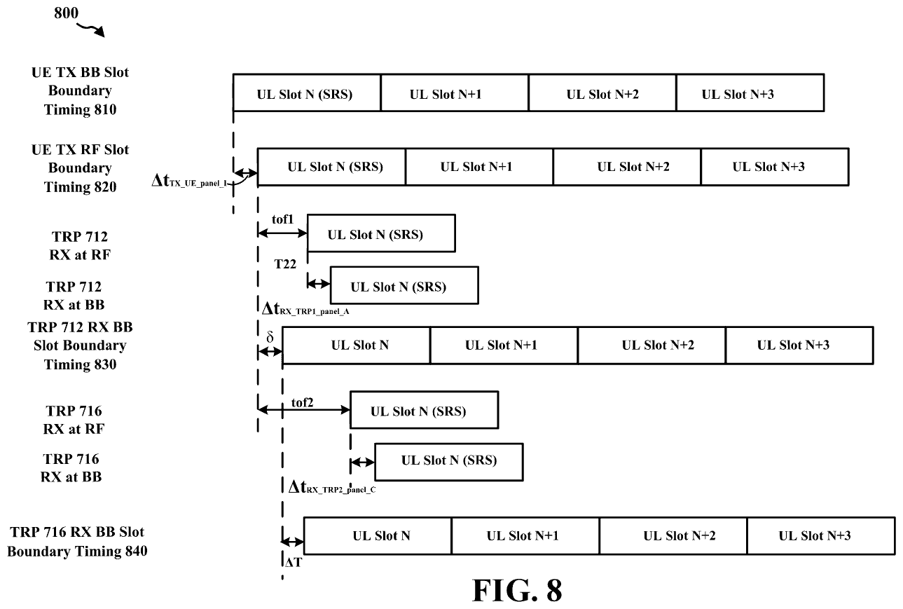

FIG. 8 is a diagram 800 illustrating uplink transmissions from the UE 704 to the TRP-1 712 and the TRP-2 716. In this example, the base station 702, which is the serving base station of the UE 704, configures (e.g., through RRC messages) the UE 704 to transmits SRSs directed to the TRP 712 and the TRP 716.

The baseband of the UE 704 in transmission operates according to UE-TX-baseband slot boundary timing 810 defining UL slots N to (N+3). The baseband signals (including SRSs) generated at the baseband are passed through a TX RF chain of the antenna-panel-I 782 of the UE 704 to generate RF signals. The TX RF chain may include a DAC, a filter, an external PA, diplexer/switch. The antenna-panel-I 782 transmits RF signals in the UL slots N to (N+3) according to a UE-TX-RF slot boundary timing 820. The UE-TX-RF slot boundary timing 820 is delayed by a Δt_{TX_UE_panel_I} comparing to the UE-TX-baseband slot boundary timing 810.

After a time of flight, in this example, tof1, the TRP-1 712 receives the signals (including the SRSs) transmitted from the UE 704 in the UL slot N at the antenna-panel-A 791. The signals pass through an RX RF chain (e.g., including a diplexer/switch, external LNA, filter, and ADC) and arrive at the baseband of the TRP-1 712 after a delay of Δt_{RX_TRP1_panel_A}.

The baseband of the TRP-1 712 determines the UL slots N to (N+3) in accordance with a TRP1-RX-baseband slot boundary timing 830. The UL slot N according to the TRP1-RX-baseband slot boundary timing 830 has a delay of δ after the UL slot N according to the UE-TX-RF slot boundary timing 820.

Similarly, after another time of flight, in this example, tof2, the TRP-2 716 receives the signals (including the SRSs) in the UL slot N at the antenna-panel-C 795. The signals pass through an RX RF chain of the TRP-2 716 and arrive at the baseband of the TRP-2 716 after a delay of Δt_{RX_TRP2_panel_C}.

The baseband of the TRP-2 716 determines the UL slots N to (N+3) in accordance with a TRP2-RX-baseband slot boundary timing 840. The UL slot N according to the TRP2-RX-baseband slot boundary timing 840 is ΔT subsequent to the UL slot N according to the TRP1-RX-baseband slot boundary timing 830. AT is the synchronization error (relative time difference) between the TRP-1 712 and the TRP-2 716 measured at the baseband.

An uplink relative time of arrival (UL-RTOA) at a TRP can be determined. In a first example, UL-RTOA #1 of SRSs from the UE 704 and arriving at the antenna-panel-A 791 of the TRP-1 712 with reference to the starting boundary of the UL slot N in accordance with TRP1-RX-baseband slot boundary timing 830 is:

$$UL - RTOA \#1 = tof 1 + Δ {t}_{RX \_ TRP 1 \_ panel \_ A} - δ .$$

Similarly, the antenna-panel-C 795 of the TRP-2 716 receives the SRSs transmitted from the antenna-panel-I 782 of the UE 704. As such, UL-RTOA #2 of SRSs from the UE 704 and arriving at the antenna-panel-C 795 of the TRP-2 716 with reference to the starting boundary of the UL slot N in accordance with TRP2-RX-baseband slot boundary timing 840 is:

$$UL - RTOA \#2 = tof 1 + Δ {t}_{RX \_ TRP 2 \_ panel \_ C} - δ - Δ T .$$

Further, UL-RSTD is defined as (UL-RTOA #1-UL-RTOA #2). Accordingly,

$$UL - RSTD = tof 1 - tof 2 + Δ T + Δ {t}_{RX \_ TRP 1 \_ panel \_ A} - Δ {t}_{RX \_ TRP 2 \_ panel \_ C} .$$

In a second example, the antenna-panel-A 791 of the TRP-1 712 receives RF signals (including SRSs 772) transmitted from the antenna-panel-I 782 of the UE 704. The antenna-panel-C 795 of the TRP-2 716 receives RF signals (including SRSs 774) transmitted from the antenna-panel-II 784 of the UE 704. As described supra, the delay from the baseband to the TX RF chain of the antenna-panel-I 782 is Δt_{TX_UE_panel_I}. Similarly, the delay from the baseband to the TX RF chain of the antenna-panel-II 784 is Δt_{TX_UE_panel_II}. Accordingly, in this second example,

$$UL - {RSTD}^{*} = tof 1 - tof 2 + Δ T + Δ {t}_{RX \_ TRP 1 \_ panel \_ A} - Δ {t}_{RX \_ TRP 2 \_ panel \_ C} + Δ {t}_{TX \_ panel \_ I} + Δ {t}_{TX \_ UE \_ panel \_ II} .$$

In this second example, the serving base station of the TRP-1 712 (e.g., the base station 702) sends measurement reports of the UL-RTOA #1 to an LMF 754 through an AMF 750. The TRP-2 716 sends measurement reports of the UL-RTOA #2 to the LMF 754. Accordingly, the LMF 754 can calculate the UL-RSTD (2).

Further, in one example, the UE 704 may send (e.g., through RRC messages) indications to its serving base station indicating that the SRSs 772 are associated with the antenna-panel-I 782 and that the SRSs 774 are associated with the antenna-panel-II 784. In other words, the indications show that the SRSs 772 are transmitted by the antenna-panel-I 782 and that the SRSs 774 are transmitted by the antenna-panel-II 784 of the UE 704. Upon receiving the indications, the serving base station sends (e.g., through NRPPa) the associations of the panels and the sets of SRSs to the LMF 754. Thus, the LMF 754 also know the associations. In another example, the UE 704 may send (e.g., through LPP messages) indications to the LMF 754 via its serving base station. The LMF 754 may send the association information back to the serving base station through NRPPa subsequently.

Subsequently, when the UE 704 changes the associations between the SRSs and the panels. The UE 704 sends another indication to its serving base station to indicate the changes or the new associations. For example, at this time, the SRSs 772 may be associated with the antenna-panel-II 784 and the SRSs 774 may be associated with the antenna-panel-I 782.

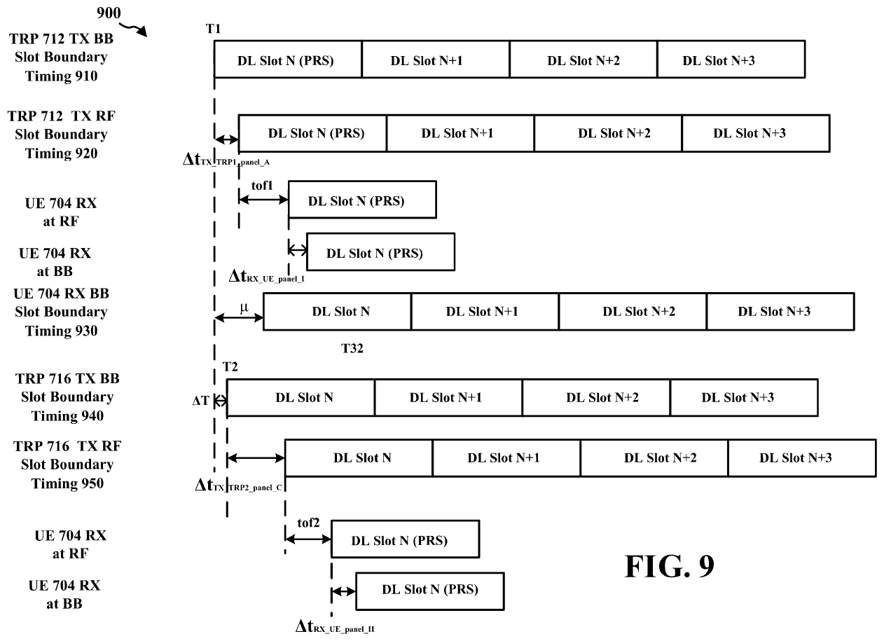

FIG. 9 is a diagram 900 illustrating downlink transmission from the TRP-1 712 and the TRP-2 716 to the UE 704. When employing the downlink time difference of arrival (DL-TDOA) positioning technique, the UE 704 measure several downlink reference signal time difference (DL-RSTD) values. Each DL-RSTD corresponds to the received time difference between two TRPs. For example, when the TRP-1 712 and the TRP-2 716 each transmit a set of PRSs at the same time point, the time difference between the UE 704 receives the PRSs from the TRP-1 712 and the TRP-2 716 is a DL-RSTD.

In this example, under the instruction of its serving base station (e.g., the base station 702), the TRP-1 712 starts to transmit a set of PRSs at time point T1. Because of a synchronization error (relative time difference), the TRP-2 716 starts to transmit a set of PRSs at time point T2, where T2=(T1+ΔT) and ΔT is the synchronization error (relative time difference) at the baseband. In other words, ΔT is the symbol boundary difference in reception at the baseband.

The baseband of the TRP-1 712 operates according to TRP1-TX-baseband slot boundary timing 910 including DL slots N to (N+3). The baseband signals (including PRSs) generated at the baseband are passed through a TX RF chain of the antenna-panel-A 791 of the TRP-1 712 to generate corresponding RF signals. The TX RF chain may include a DAC, a filter, an external PA, and a diplexer/switch. The antenna-panel-A 791 transmits the RF signals in the DL slots N to (N+3) according to a TRP1-TX-RF slot boundary timing 920. The TRP1-TX-RF slot boundary timing 920 is delayed by a Δt_{TX_TRP1_panel_A} comparing to the TRP1-TX-baseband slot boundary timing 910.

After a time of flight, in this example, tof1, the UE 704 receives the signals (including PRSs) transmitted from the TRP-1 712 in the DL slot N at the antenna-panel-I 782. The signals pass through an RX RF chain (e.g., including a diplexer/switch, external LNA, filter, and ADC) of the antenna-panel-I 782 and arrive at the baseband of the UE 704 after a delay of Δt_{RX_UE_panel_I}.

The baseband of the UE 704 determines the DL slots N to (N+3) in accordance with a UE-RX-baseband slot boundary timing 930. The DL slot N according to the UE-RX-baseband slot boundary timing 930 has a delay of μ after the DL slot N according to the TRP1-TX-baseband slot boundary timing 910.

Similarly, the baseband of the TRP-2 716 operates according to TRP2-TX-baseband slot boundary timing 940 including DL slots N to (N+3). The baseband signals (including PRSs) generated at the baseband are passed through a TX RF chain of the antenna-panel-C 795 of the TRP-2 716 to generate corresponding RF signals. The antenna-panel-C 795 transmits the RF signals in the DL slots N to (N+3) according to a TRP2-TX-RF slot boundary timing 950. The TRP2-TX-RF slot boundary timing 950 is delayed by a Δt_{TX_TRP2_panel_C} comparing to the TRP2-TX-baseband slot boundary timing 940. Further, there is a synchronization error (relative time difference) ΔT between the TRP1-TX-baseband slot boundary timing 910 and the TRP2-TX-baseband slot boundary timing 940.

After another time of flight, in this example, tof2, the UE 704 receives the signals (including PRSs) transmitted from the TRP-2 716 in the DL slot N at the antenna-panel-II 784. The signals pass through an RX RF chain of the antenna-panel-II 784 and arrive at the baseband of the UE 704 after a delay of Δt_{RX_UE_panel_II}.

A downlink relative time of arrival (DL-RTOA) of a PRS arriving at a UE can be determined. DL-RTOA #1 of the DL slot N transmitted from the antenna-panel-A 791 of the TRP-1 712 and arriving at the antenna-panel-I 782 of the UE 704 with reference to the starting boundary of the DL slot N in accordance with UE-RX-baseband slot boundary timing 930 is:

$$DL - RTOA \#1 = Δ {t}_{RX \_ TRP 1 \_ panel \_ A} + tof 1 + Δ {t}_{TX \_ panel \_ I} - μ .$$

In this example, similarly, the antenna-panel-II 784 of the UE 704 receives the RF signals (including PRSs) transmitted from the antenna-panel-C 795 of the TRP-2 716. DL-RTOA #2 of the DL slot N transmitted from the antenna-panel-C 795 of the TRP-2 716 and arriving at the antenna-panel-II 784 of the UE 704 with reference to the starting boundary of the DL slot N in accordance with UE-RX-baseband slot boundary timing 930 is:

$$DL - RTOA \#2 = Δ T + Δ {t}_{RX \_ TRP 2 \_ panel \_ C} + tof 2 + Δ {t}_{RX \_ UE \_ panel \_ II} - μ .$$

Further, DL-RSTD* is defined as (DL-RTOA #1-DL-RTOA #2) as follows when considering different antenna panels:

$$DL - {RSTD}^{*} = tof 1 - tof 2 - Δ T + Δ {t}_{TX \_ TRP 1 \_ panel \_ A} - Δ {t}_{TX \_ TRP 2 \_ panel \_ C} + Δ {t}_{RX \_ panel \_ I} + Δ {t}_{RX \_ UE \_ panel \_ II} .$$

As such, the UE 704 can calculate a DL-RSTD* with respect to the TRP-1 712 and the TRP-2 716. The UE 704 sends the DL-RSTD* to its serving base station (e.g., the base station 702), which forwards the DL-RSTD* to the LMF 754.

In certain configurations, the UE 704 can also send to the serving base station indications whether the DL-RTOAs used to generate the DL-RSTD* are measured at the RX RF chain of the same panel (e.g., the antenna-panel-I 782) or measured at RX RF chains of different panels of the UE 704 (e.g., both the antenna-panel-I 782 and the antenna-panel-II 784). In certain configurations, the UE 704 can send indications whether the DL-RTOAs used to generate the DL-RSTD* are measured at RX RF chains at the same delay error level (i.e., in the same timing error group (TEG)) or RX RF chains at different delay error levels (i.e., in different TEGs).

In certain configurations, the UE 704, the TRP-1 712, and the TRP-2 716 each have self calibration capabilities to determine the total delays of the TX RF chain and the RX RF chain at a antenna panel. In particular, the UE 704 can determine:

$${Delay\_Sum}_{( UE \_ panel \_ I )} = Δ {t}_{RX \_ panel \_ I} + Δ {t}_{TX \_ panel \_ I} , and$$

$${Delay\_Sum}_{( UE \_ panel \_ II )} = Δ {t}_{RX \_ panel \_ II} + Δ {t}_{TX \_ panel \_ II} .$$

The TRP-1 712 can determine

$${Delay\_Sum}_{( TRPI \_ panel \_ A )} = Δ {t}_{RX \_ TRP 1 \_ panel \_ A} + Δ {t}_{TX \_ TRP 1 \_ panel \_ A} .$$

The TRP-2 716 can determine

$${Delay\_Sum}_{( TRP 2 \_ panel \_C )} = Δ {t}_{RX\_TRP 2 \_ p anel \_C} + Δ {t}_{TX\_TRP 2 \_ p anel \_C} .$$

The UE 704 can compensate/modify the DL-RSTD* with the Delay_Sum_{(UE_panel_I)} and the Delay_Sum_{(UE_panel_II)}. For example, the compensated (modified) DL-RSTD* can be:

$$DL - RSTD ’ = DL - {RSTD}^{*} - ( {Delay\_Sum}_{( UE\_panel \_I )} + {Delay\_Sum}_{( UE\_panel \_II )} ) = t of 1 - t of 2 - Δ T + Δ {t}_{TX\_TRP 1 \_ p anel \_A} - Δ {t}_{TX\_TRP 2 \_ p anel \_C} - Δ {t}_{TX\_UE \_panel \_I} + Δ {t}_{TX\_UE \_panel \_II} .$$

Accordingly, the UE 704 sends the DL-RSTD′ to the serving base station, which forwards the DL-RSTD′ to the LMF 754. Alternatively, the UE 704 may send the DL-RSTD* as well as the Delay_Sum_{(UE_panel_I)} and/or Delay_Sum_{(UE_panel_II)} to the serving base station. Further, the UE 704 may send the difference between the Delay_Sum_{(UE_panel_I)} and Delay_Sum_{(UE_panel_II)} to the serving base station. The serving base station can forward these values to the LMF 754, which can accordingly calculate the DL-RSTD′.

The TRP-1 712 can compensate/modify the UL-RTOA #1 with the Delay_Sum_{(TRP1_panel_A)}. For example, the compensated (modified) UL-RTOA #1 can be:

$$UL - RTOA \# 1 ’ = UL - RTOA \# 1 - {Delay\_Sum}_{( TRP 1 \_ panel \_A )} = t of 1 - Δ {t}_{TX\_TRP 1 \_ p anel \_A} - δ .$$

Accordingly, the TRP-1 712 may report the UL-RTOA #1′ to the LMF 754.

The TRP-2 716 can compensate/modify the UL-RTOA #2 with the Delay_Sum_{(TRP2_panel_C)}. The UL-RTOA #2 is:

$$t of 2 + Δ {t}_{TX\_UE \_panel \_II} - Δ {t}_{TX\_UE \_panel \_I} + Δ {t}_{RX\_TRP 2 \_ p anel \_C} - δ - Δ T .$$

The compensated (modified) UL-RTOA #2 can be:

$$UL - RTOA \# 2 ’ = UL - RTOA \# 2 - {Delay\_Sum}_{( TRP 2 \_ panel \_C ) \cdot } = t of 2 - Δ {t}_{TX\_TRP 2} - δ - Δ T + Δ {t}_{TX\_UE \_panel \_II} - Δ {t}_{TX\_UE \_panel \_I}$$

Accordingly, the TRP-2 716 may report the UL-RTOA #2′ to the LMF 754.

When the LMF 754 receives the UL-RTOA #1′ and the UL-RTOA #2′ from the TRP-1 712 and the TRP-2 716, respectively, the LMF 754 can calculate a compensated (modified) UL-RSTD as:

$$UL - RSTD ’ = t of 1 - t of 2 + Δ T - Δ {t}_{TX\_TRP 1 \_ p anel \_A} + Δ {t}_{TX\_TRP 2 \_ p anel \_C} - Δ {t}_{TX\_UE \_panel \_I} - Δ {t}_{TX\_UE \_panel \_II} .$$

In a first configuration, the LMF 754 receives the DL-RSTD′ (modified DL-RSTD*) generated by the UE 704 from the serving base station of the UE 704. The LMF 754 also receives the UL-RTOA #1′ and the UL-RTOA #2′ from the TRP-1 712 and the TRP-2 716, respectively. Thus, the LMF 754 can calculate the UL-RSTD′.

Further, the LMF 754 can calculate a value that is:

$$UL - RSTD ’ + DL - RSTD ’ = 2 * ( t of 1 - t of 2 ) .$$

The LMF 754 can also calculate another value:

$$UL - RSTD ’ + DL - RSTD ’ = - 2 * ( Δ T - Δ {t}_{TX\_TRP 1 \_ p anel \_A} + Δ {t}_{TX\_TRP 2 \_ p anel \_C} + Δ {t}_{TX\_UE \_panel \_I} - Δ {t}_{TX\_UE \_panel \_II} )$$

When the PRSs from the TRP-1 712 and the TRP-2 716 are received by the same panel (e.g., the antenna-panel-I 782), the value (ΔT−Δt_{TX_TRP1_panel_A}+Δt_{TX_TRP2_panel_C}) can be calculated. Based on that value, the value of (Δt_{TX_UE_panel_I}−Δt_{TX_UE_panel_II}) can also be derived.

In a second configuration, the LMF 754 receives the DL-RSTD′ (modified DL-RSTD*) generated by the UE 704 from the serving base station of the UE 704 as described supra:

$$DL - RSTD ’ = t of 1 - t of 2 - Δ T + Δ {t}_{TX\_TRP 1 \_ p anel \_A} - Δ {t}_{TX\_TRP 2 \_ p anel \_C} - Δ {t}_{TX\_UE \_panel \_I} + Δ {t}_{TX\_UE \_panel \_II} .$$

The LMF 754 also receives the unmodified UL-RTOA #1 and the unmodified UL-RTOA #2 from the TRP-1 712 and the TRP-2 716, respectively. Thus, the LMF 754 can calculate as described supra:

$$UL - {RSTD}^{*} = t of 1 - t of 2 + Δ T + Δ {t}_{R X\_TRP 1 \_ p anel \_A} - Δ {t}_{RX\_TRP 2 \_ p anel \_C} - Δ {t}_{TX\_UE \_panel \_I} + Δ {t}_{TX\_UE \_panel \_II} .$$

Further, an uplink relative time difference (RTD) at TRPs or TRP side impairment can be defined as

$${RTD}_{TRP\_uplink} = Δ T + Δ {t}_{RX\_TRP 1 \_ p anel \_A} - Δ {t}_{RX\_TRP 2 \_ p anel \_C} .$$

A downlink RTD at TRPs or TRP side impairment can be defined as

$${RTD}_{TRP\_downlink} = - Δ T + Δ {t}_{TX\_TRP 1 \_ p anel \_A} - Δ {t}_{TX\_TRP 2 \_ p anel \_C} .$$

An uplink RTD at the UE or UE side impairment can be defined as

$${RTD}_{UE\_uplink} = Δ {t}_{TX\_UE \_ p anel \_I} - Δ {t}_{TX\_UE \_ p anel \_II} .$$

A downlink RTD at the UE or UE side impairment can be defined as

$${RTD}_{UE\_downlink} = Δ {t}_{RX\_UE \_ p anel \_I} - Δ {t}_{RX\_UE \_ p anel \_II} .$$

In this configuration, a PRU 790 (a positioning reference unit or reference device) is similarly in communication with (e.g., sending SRSs to and receiving PRSs from) the TRP-1 712 and TRP-2 716. The PRU 790 may have an antenna-panel-III 793 and an antenna-panel-IV 794. The location of the PRU 790 is known by its serving base station (e.g., the base station 702). Therefore, the TRP-1 712 can determine the value of tof1 and the TRP-2 716 can determine the value of tof2. In addition, the serving base station reports the ID of the PRU 790 as well as the location coordinates of the PRU 790 to the LMF 754. Further, the LMF 754 can estimate the downlink RTD based on measurements conducted at the PRU 790. The LMF 754 can also estimate the uplink RTD based on measurements, conducted at a TRP, of a transmission from the PRU 790.

The UE 704 reports the statistics (e.g., mean and variance) of the RTD_{UE_uplink} (i.e., the transmission group delay difference between the antenna-panel-I 782 and the antenna-panel-II 784) to its serving base station, which forwards the values to the LMF 754.

After receiving the above information, the LMF 754 can determine the RTD_{TRP_downlink} based on the measurements of the PRU. The LMF 754 can also determine the RTD_{TRP_uplink} based on the measurements reports by the TRPs and transmission by the PRU.

As such, with respect to the UE 704, the LMF 754 can perform the following calculations:

$$DL - RSTD ’ + UL - RST {D}^{*} - {RTD}_{TRP\_downlink} - {RTD}_{TRP\_uplink} = t of 1 - t of 2$$

$$DL - RSTD ’ - UL - RST {D}^{*} - {RTD}_{TRP\_downlink} + {RTD}_{TRP\_uplink} = - 2 * ( Δ {t}_{TX\_UE \_ p anel \_I} - Δ {t}_{TX\_UE \_ p anel \_II} ) .$$

In order to for the LMF 754 to distinguish the transmission from the antenna-panel-I 782 and the antenna-panel-II 784 of the UE 704, the resources (e.g., resource elements (REs) or resource sets at particular locations of time domain and frequency domain) used for each SRS transmission are associated with an ID representing a particular panel (RF chain) used at the UE 704 or representing a particular delay error level used to group panels with similar properties. An SRS resource may occupy a number of subcarriers and OFDM symbols (i.e., REs). Two panels may share the same ID if their respective delay error levels are very close to each other (e.g., in the same TEG). The UE 704 can determine the association between the SRSs and the panels, and provide the association information to the LMF 754.

In certain configurations, when the network configures an SRS resource to the UE through an information element (IE), the IE also contains indications of a spatial relation reference signal (e.g., a downlink RS). The UE may measure the spatial relation reference signal to determine whether the pair of TX and RX RF chains receiving the spatial relation reference signal is suitable to transmit the corresponding SRS. If the pair of TX and RX RF chains does not receive the spatial relation reference signal correctly, likely an SRS transmitted by this pair of TX and RX RF chain may not be received correctly at the TRP. Further, the UE may measure the spatial relation reference signal to determine the transmit beam direction from the TRP.

If the SRS resource set or resources associated with a particular panel (RF chain) for transmission are changed, the change of association or the new association is reported to LMF 754 with a time stamp.

In certain configurations, the LMF 754 may combine the TRP measurements having SRS transmissions from the same RF chain of a UE to reduce the impact of different group delay between RF chains.

In certain configurations, the LMF 754 may through higher layer signaling request the UE 704 to transmit from another antenna panel (RF chain) in order to improve dilution of precision (DOP). This is because each antenna panel may not transmit the signal to all the surrounding TRPs due to strong directivity.

Similarly, each PRS transmission may be associated with an ID representing a particular panel (RF chain) used at the transmitting TRP (e.g., the TRP-1 712 or the TRP-2 716) or representing a particular delay error level used to group panels with similar properties. Two panels may share the same ID if their respective delay error levels are very close to each other. The TRP can determine the association between the PRSs and the panels, and provide the association information to the LMF 754.

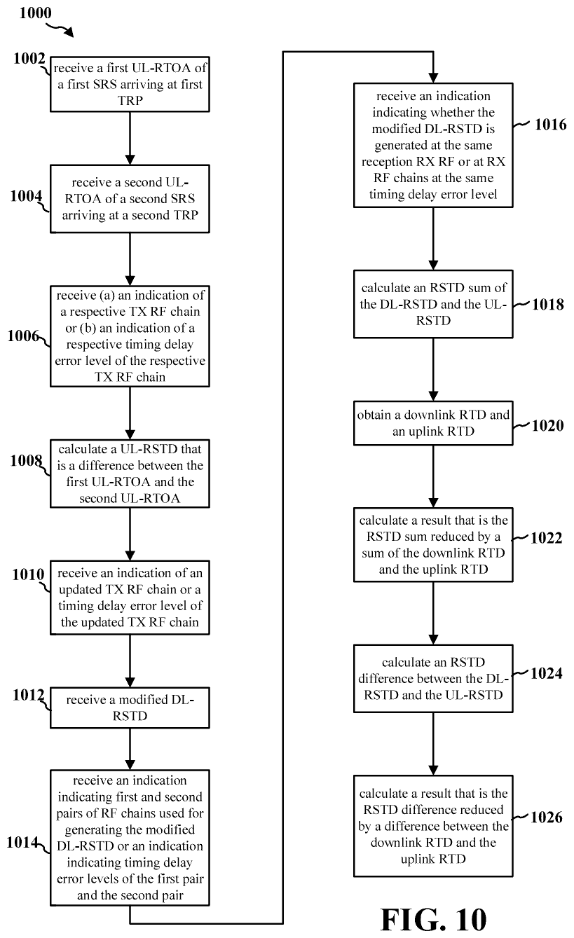

FIG. 10 is a flow chart 1000 of a method (process) for processing location data. The method may be performed by a location management function (e.g., the LMF 754). At operation 1002, the location management function receives a first UL-RTOA of a first SRS (e.g., the SRSs 772) arriving at first TRP (e.g., the TRP-1 712). At operation 1004, the location management function receives a second UL-RTOA of a second SRS (e.g., the SRSs 774) arriving at a second TRP (e.g., the TRP-2 716). At operation 1006, the location management function receives (a) an indication of a respective TX RF chain of a UE associated with each of the first SRS and the second SRS or (b) an indication of a respective timing delay error level (or timing error group (TEG)) of the respective TX RF chain associated with each of the first SRS and the second SRS.

At operation 1008, the location management function calculates a UL-RSTD that is a difference between the first UL-RTOA and the second UL-RTOA based on the indication of the respective TX RF chain or the indication of the respective timing delay error level. At operation 1010, the location management function receives an indication of an updated TX RF chain of the UE that is associated with the SRS or an indication of a timing delay error level of the updated TX RF chain.

At operation 1012, the location management function receives a modified DL-RSTD. At operation 1014, the location management function receives, from the UE, an indication indicating the first pair of TX and RX RF chains and the second pair of TX and RX RF chains that are used for generating the modified DL-RSTD or an indication indicating a timing delay error level of the first pair and a timing delay error level of the second pair. In particular, as described supra, in the present disclosure, a timing delay error level of a given pair of TX and RX RF chains may be (a) a timing delay error level of the TX RF chain, individually, of the pair, (b) a timing delay error level of the RX RF chain, individually, of the pair, or (c) a timing delay error level of the TX and RX RF chains, collectively, of the pair. At operation 1016, the location management function receives, from the UE, (a) an indication indicating whether the modified DL-RSTD is generated based on two measurements of DL-RTOA of PRSs at a RX RF chain or two different RX RF chains of the UE or (b) an indication indicating whether the DL-RSTD is generated based on two measurements of DL-RTOA of PRSs at RX RF chains that are at a same timing delay error level or that are at different timing delay error levels. At operation 1018, the location management function calculates an RSTD sum of the DL-RSTD and the UL-RSTD.

At operation 1020, the location management function obtains a downlink RTD and an uplink RTD between the first TRP and the second TRP. In certain configurations, the downlink RTD is a baseband symbol boundary difference in transmission between the first TRP and the second TRP increased by a difference between the transmission group delay at the first TRP and the transmission group delay at the second TRP. The uplink RTD is a baseband symbol boundary difference in reception between the first TRP and the second TRP increased by a difference between the reception group delay at the first TRP and the reception group delay at the second TRP. At operation 1022, the location management function calculates a result that is the RSTD sum reduced by a sum of the downlink RTD and the uplink RTD. Further, the location management function can estimate the downlink RTD based on measurements conducted at a PRU. The location management function can also estimate the uplink RTD based on measurements, conducted at the TRP, of a transmission from the PRU. At operation 1024, the location management function calculates an RSTD difference between the DL-RSTD and the UL-RSTD. At operation 1026, the location management function calculates a result that is the RSTD difference reduced by a difference between the downlink RTD and the uplink RTD.

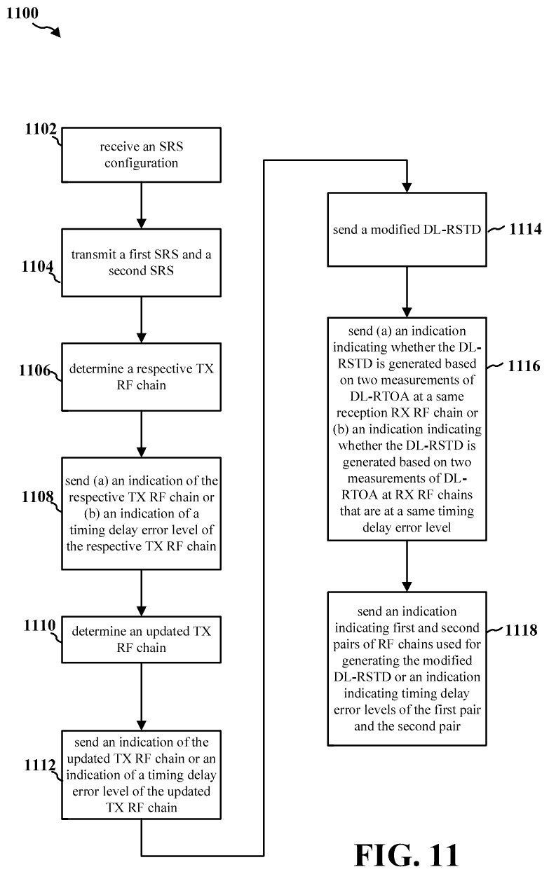

FIG. 11 is a flow chart 1100 of a method (process) for sending location data. The method may be performed by a UE (e.g., the UE 704). At operation 1102, the UE receives an SRS configuration from a serving base station (e.g., the base station 702). At operation 1104, the UE transmits a first SRS (e.g., the SRSs 772) and a second SRS (e.g., the SRSs 774) in accordance with the SRS configuration. At operation 1106, in certain configurations, the UE may determine a respective TX RF chain (e.g., that of the antenna-panel-I 782 or that of the antenna-panel-II 784) associated with each of the first SRS and the second SRS based on a measurement of a spatial relation reference signal transmitted on a transmit beam from a TX RF chain of a TRP (e.g., the TRP-1 712). At operation 1108, the UE sends, to a network, (a) an indication of a respective TX RF chain of the UE associated with each of the first SRS and the second SRS or (b) an indication of a timing delay error level of the respective TX RF chain associated with each of the first SRS and the second SRS.

At operation 1110, the UE determines an updated TX RF chain that is associated with the first SRS or the second SRS. At operation 1112, the UE sends an indication of the updated TX RF chain or an indication of a timing delay error level of the updated TX RF chain. At operation 1114, the UE sends, to the network, a modified downlink reference signal time difference (DL-RSTD) measured at the UE with respect to the first TRP and the second TRP. The modified DL-RSTD is compensated with a first delay sum of a transmission group delay and a reception group delay at a first pair of TX and RX RF chains of the UE and with a second delay sum of a transmission group delay and a reception group delay at a second pair of TX and RX RF chains of the UE.

At operation 1116, in certain configurations, the UE may send (a) an indication indicating whether the DL-RSTD is generated based on two measurements of DL-RTOA of PRSs at a same RX RF chain or two different RX RF chains of the UE or (b) an indication indicating whether the DL-RSTD is generated based on two measurements of DL-RTOA of PRSs at RX RF chains that are at a same timing delay error level or that are at different timing delay error levels. At operation 1118, in certain configurations, the UE may send, to the network, an indication indicating the first pair of TX and RX RF chains and the second pair of TX and RX RF chains that are used for generating the modified DL-RSTD or an indication indicating a timing delay error level of the first pair and a timing delay error level of the second pair. In particular, as described supra, in the present disclosure, a timing delay error level of a given pair of TX and RX RF chains may be (a) a timing delay error level of the TX RF chain, individually, of the pair, (b) a timing delay error level of the RX RF chain, individually, of the pair, or (c) a timing delay error level of the TX and RX RF chains, collectively, of the pair.

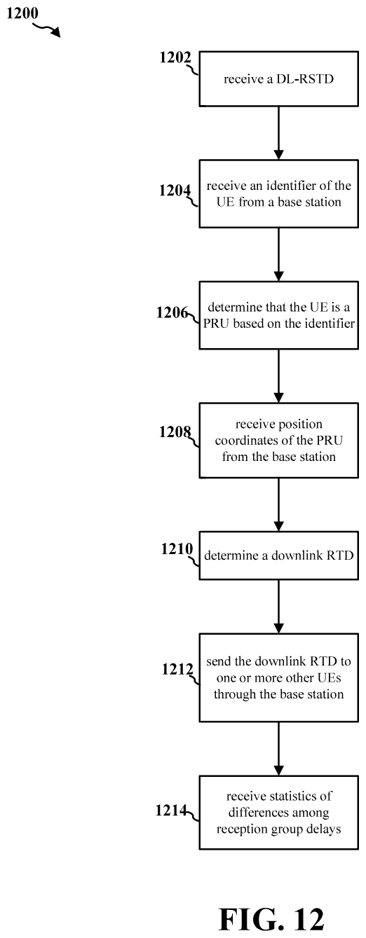

FIG. 12 is a flow chart 1200 of a method (process) for processing location data in connection with a DL-RSTD. The method may be performed by a location management function (e.g., the LMF 754). At operation 1202, the location management function receives a DL-RSTD measured at a UE (e.g., the PRU 790) with respect to a first TRP and a second TRP. At operation 1204, the location management function receives an identifier of the UE from a base station (e.g., the base station 702). At operation 1206, the location management function determines that the UE is a PRU based on the identifier. At operation 1208, the location management function receives position coordinates of the PRU from the base station.

At operation 1210, the location management function determines a downlink RTD based on the DL-RSTD received from the PRU and the coordinates of the PRU. The downlink RTD is associated with a baseband symbol boundary difference in transmission between the first TRP and the second TRP and a difference between a transmission group delay at the first TRP and a transmission group delay at the second TRP. At operation 1212, the location management function sends the downlink RTD to one or more other UEs through the base station. At operation 1214, the location management function receives statistics of a difference between the reception group delay at the first pair of TX and RX RF chains and the reception group delay at the second pair of TX and RX RF chains of each of one or more other UEs.

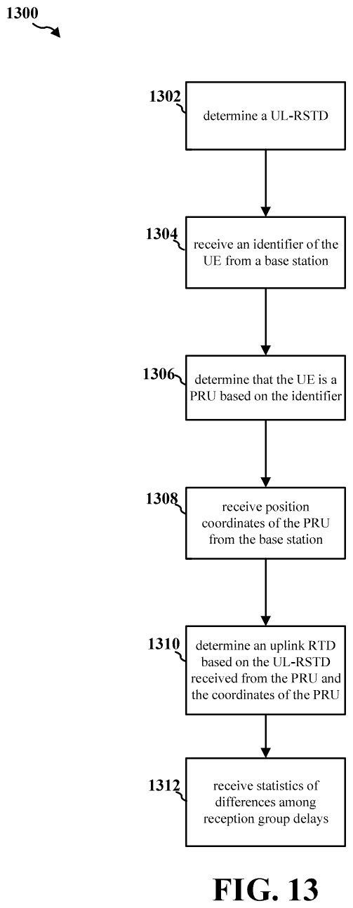

FIG. 13 is a flow chart 1300 of a method (process) for processing location data in connection with a UL-RSTD. The method may be performed by a location management function (e.g., the LMF 754). At operation 1302, the location management function determines a UL-RSTD that is a difference between a first UL-RTOA of an SRS arriving at a first TRP (e.g., the TRP-1 712) and a second UL-RTOA of the SRS arriving at a second TRP (the TRP-2 716). At operation 1304, the location management function receiving an identifier of the UE from a base station. At operation 1306, the location management function determines that the UE is a PRU based on the identifier. At operation 1308, the location management function receiving position coordinates of the PRU from the base station. At operation 1310, the location management function determining an uplink RTD based on the UL-RSTD received from the PRU and the coordinates of the PRU. The uplink RTD is associated with a baseband symbol boundary difference in reception between the first TRP and the second TRP and a difference between a reception group delay at the first TRP and a reception group delay at the second TRP. At operation 1312, the location management function receives statistics of a difference between the reception group delay at the first pair of TX and RX RF chains and the reception group delay at the second pair of TX and RX RF chains of each of one or more other UEs.

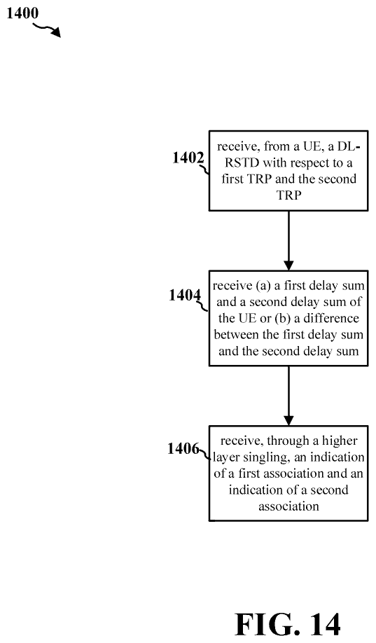

FIG. 14 is a flow chart 1400 of another method (process) for processing location data in connection with a DL-RSTD. The method may be performed by a location management function (e.g., the LMF 754). At operation 1402, the location management function receives, from a UE (e.g., the UE 704), a DL-RSTD with respect to a first TRP and the second TRP. At operation 1404, the location management function receives (a) a first delay sum of a transmission group delay and a reception group delay at a first pair of TX and RX RF chains of the UE and a second delay sum of a transmission group delay and a reception group delay at a second pair of TX and RX RF chains of the UE or (b) a difference between the first delay sum and the second delay sum. At operation 1406, the UE receives, through a higher layer singling, an indication of a first association of the first delay sum with the first pair of TX and RX RF chains and an indication of a second association of the second delay sum with the second pair of TX and RX RF chains.

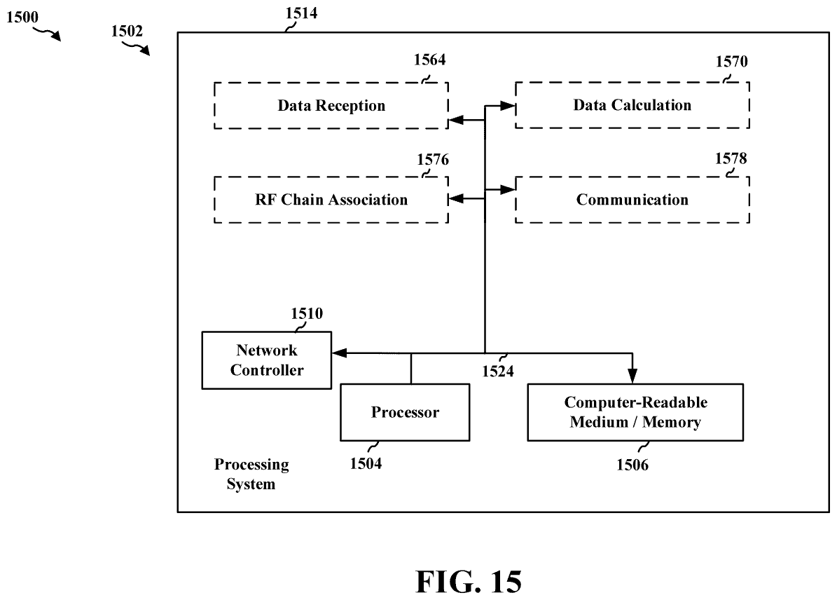

FIG. 15 is a diagram 1500 illustrating an example of a hardware implementation for an apparatus 1502 employing a processing system 1514 and one or more other hardware components. The apparatus 1502 may implement the location management function. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the computer-readable medium/memory 1506, a network controller 1510, etc.

The bus 1524 may also link various other circuits such as timing sources, peripherals, voltage regulators, and power management circuits, which are well known in the art, and therefore, will not be described any further.

The processing system 1514 may be coupled to the network controller 1510. The network controller 1510 provides a means for communicating with various other apparatus over a network. The network controller 1510 receives a signal from the network, extracts information from the received signal, and provides the extracted information to the processing system 1514, specifically a communication component 1578. In addition, the network controller 1510 receives information from the processing system 1514, specifically the communication component 1578, and based on the received information, generates a signal to be sent to the network. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system further includes at least one of a data reception component 1564, a data calculation component 1570, and a RF chain association component 1576. The components may be software components running in the processor 1504, resident/stored in the computer readable medium/memory 1506, one or more hardware components coupled to the processor 1504, or some combination thereof.

The apparatus 1502 has means for performing operations described supra referring to FIGS. 10 and 12-14. The aforementioned means may be one or more of the aforementioned components of the apparatus 1502 and/or the processing system 1514 of the apparatus 1502 configured to perform the functions recited by the aforementioned means.

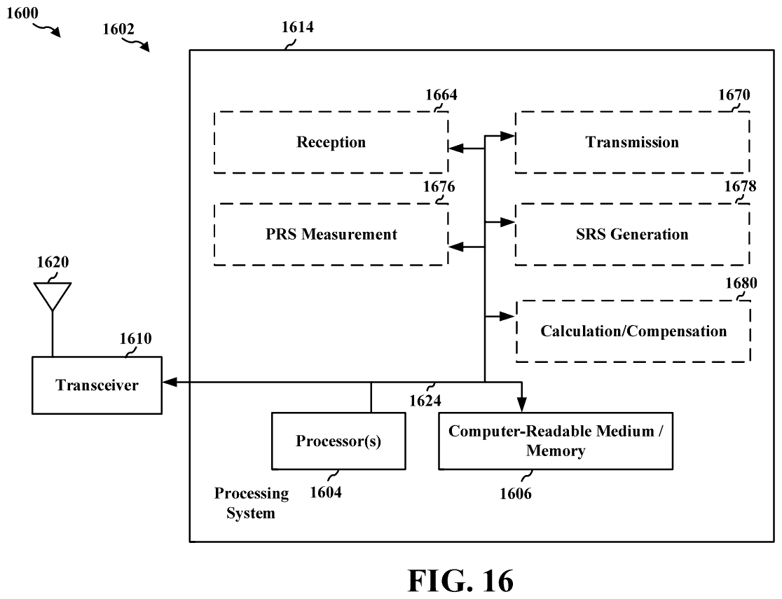

FIG. 16 is a diagram 1600 illustrating an example of a hardware implementation for an apparatus 1602 employing a processing system 1614 and one or more other hardware components. The apparatus 1602 may be a UE. The processing system 1614 may be implemented with a bus architecture, represented generally by a bus 1624. The bus 1624 may include any number of interconnecting buses and bridges depending on the specific application of the processing system 1614 and the overall design constraints. The bus 1624 links together various circuits including one or more processors and/or hardware components, represented by one or more processors 1604, a reception component 1664, a transmission component 1670, a PRS measurement component 1676, an SRS generation component 1678, a calculation/compensation component 1680, and a computer-readable medium/memory 1606. The bus 1624 may also link various other circuits such as timing sources, peripherals, voltage regulators, and power management circuits, etc.

The processing system 1614 may be coupled to a transceiver 1610, which may be one or more of the transceivers 254. The transceiver 1610 is coupled to one or more antennas 1620, which may be the communication antennas 252.

The transceiver 1610 provides a means for communicating with various other apparatus over a transmission medium. The transceiver 1610 receives a signal from the one or more antennas 1620, extracts information from the received signal, and provides the extracted information to the processing system 1614, specifically the reception component 1664. In addition, the transceiver 1610 receives information from the processing system 1614, specifically the transmission component 1670, and based on the received information, generates a signal to be applied to the one or more antennas 1620.

The processing system 1614 includes one or more processors 1604 coupled to a computer-readable medium/memory 1606. The one or more processors 1604 are responsible for general processing, including the execution of software stored on the computer-readable medium/memory 1606. The software, when executed by the one or more processors 1604, causes the processing system 1614 to perform the various functions described supra for any particular apparatus. The computer-readable medium/memory 1606 may also be used for storing data that is manipulated by the one or more processors 1604 when executing software. The processing system 1614 further includes at least one of the reception component 1664, the transmission component 1670, the PRS measurement component 1676, the SRS generation component 1678, and the calculation/compensation component 1680. The components may be software components running in the one or more processors 1604, resident/stored in the computer readable medium/memory 1606, one or more hardware components coupled to the one or more processors 1604, or some combination thereof. The processing system 1614 may be a component of the UE 250 and may include the memory 260 and/or at least one of the TX processor 268, the RX processor 256, and the communication processor 259.

In one configuration, the apparatus 1602 for wireless communication includes means for performing each of the operations of FIG. 11. The aforementioned means may be one or more of the aforementioned components of the apparatus 1602 and/or the processing system 1614 of the apparatus 1602 configured to perform the functions recited by the aforementioned means.

As described supra, the processing system 1614 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, Conly, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of operating a location management function, comprising:
receiving, at the location management function, a first uplink relative time of arrival (UL-RTOA) of a first SRS arriving at first transmission and reception point (TRP);
receiving, at the location management function, a second UL-RTOA of a second SRS arriving at a second TRP;
receiving, at the location management function, (a) an indication of a respective transmission (TX) radio frequency (RF) chain of a UE associated with each of the first SRS and the second SRS or (b) an indication of a respective timing delay error level of the respective TX RF chain associated with each of the first SRS and the second SRS; and
calculating a UL-RSTD that is a difference between the first UL-RTOA and the second UL-RTOA based on the indication of the respective TX RF chain or the indication of the respective timing delay error level.

2. The method of claim 1, further comprising:
receiving an indication of an updated TX RF chain of the UE that is associated with the SRS or an indication of a timing delay error level of the updated TX RF chain.

3. The method of claim 1, further comprising:
receiving a modified downlink reference signal time difference (DL-RSTD).

4. The method of claim 3, further comprising:
receiving, from the UE, an indication indicating the first pair of TX and RX RF chains and the second pair of TX and RX RF chains that are used for generating the modified DL-RSTD or an indication indicating a timing delay error level of the first pair and a timing delay error level of the second pair.

5. The method of claim 3, further comprising:
receiving, from the UE, (a) an indication indicating whether the modified DL-RSTD is generated based on two measurements of downlink relative time of arrival (DL-RTOA) of positioning reference signals (PRSs) at a same reception (RX) radio frequency (RF) chain or two different RX RF chains of the UE or (b) an indication indicating whether the DL-RSTD is generated based on two measurements of DL-RTOA of PRSs at RX RF chains that are at a same timing delay error level or that are at different timing delay error levels.

6. The method of claim 3, further comprising:
calculating an RSTD sum of the DL-RSTD and the UL-RSTD.

7. The method of claim 6, further comprising:
obtaining a downlink relative timing difference (RTD) between the first TRP and the second TRP;
obtaining an uplink RTD between the first TRP and the second TRP; and
calculating a result that is the RSTD sum reduced by a sum of the downlink RTD and the uplink RTD.

8. The method of claim 7, wherein the downlink RTD is a baseband symbol boundary difference in transmission between the first TRP and the second TRP increased by a difference between the transmission group delay at the first TRP and the transmission group delay at the second TRP; and
wherein the uplink RTD is a baseband symbol boundary difference in reception between the first TRP and the second TRP increased by a difference between the reception group delay at the first TRP and the reception group delay at the second TRP.

9. The method of claim 8, further comprising:
estimating, at the location management function, the downlink RTD based on measurements conducted at a positioning reference unit (PRU); or
estimating, at the location management function, the uplink RTD based on measurements, conducted at the TRP, of a transmission from the PRU.

10. The method of claim 3, further comprising:
calculating an RSTD difference between the DL-RSTD and the UL-RSTD.

11. The method of claim 10, further comprising:
obtaining a downlink relative timing difference (RTD) between the first TRP and the second TRP;
obtaining an uplink RTD between the first TRP and the second TRP; and
calculating a result that is the RSTD difference reduced by a difference between the downlink RTD and the uplink RTD.

12. A method of wireless communication of a user equipment (UE), comprising:
receiving, from a serving base station of the UE, a sounding reference signal (SRS) configuration;
transmitting a first SRS and a second SRS in accordance with the SRS configuration; and
sending, to a network, (a) an indication of a respective transmission (TX) radio frequency (RF) chain of the UE associated with each of the first SRS and the second SRS or (b) an indication of a timing delay error level of the respective TX RF chain associated with each of the first SRS and the second SRS.

13. The method of claim 12, further comprising:
determining the respective TX RF chain associated with each of the first SRS and the second SRS based on a measurement of a spatial relation reference signal transmitted on a transmit beam from a TX RF chain of a TRP.

14. The method of claim 13, further comprising:
determining an updated TX RF chain that is associated with the first SRS or the second SRS; and
sending an indication of the updated TX RF chain or an indication of a timing delay error level of the updated TX RF chain.

15. The method of claim 12, further comprising:
sending, to the network, a modified downlink reference signal time difference (DL-RSTD) measured at the UE with respect to the first TRP and the second TRP, wherein the modified DL-RSTD is compensated with a first delay sum of a transmission group delay and a reception group delay at a first pair of TX and RX RF chains of the UE and with a second delay sum of a transmission group delay and a reception group delay at a second pair of TX and RX RF chains of the UE.

16. The method of claim 15, further comprising:
sending, from the UE, (a) an indication indicating whether the DL-RSTD is generated based on two measurements of downlink relative time of arrival (DL-RTOA) of positioning reference signals (PRSs) at a same reception (RX) radio frequency (RF) chain or two different RX RF chains of the UE or (b) an indication indicating whether the DL-RSTD is generated based on two measurements of DL-RTOA of PRSs at RX RF chains that are at a same timing delay error level or that are at different timing delay error levels.

17. The method of claim 15, further comprising:
sending, to the network, an indication indicating the first pair of TX and RX RF chains and the second pair of TX and RX RF chains that are used for generating the modified DL-RSTD or an indication indicating a timing delay error level of the first pair and a timing delay error level of the second pair.

18. A method of operating a location management function, comprising:
receiving a downlink reference signal time difference (DL-RSTD) measured at a UE with respect to a first transmission and reception point (TRP) and a second TRP;
receiving an identifier of the UE from a base station;
determining that the UE is a positioning reference unit (PRU) based on the identifier;
receiving position coordinates of the PRU from the base station; and
determining a downlink relative time difference (RTD) based on the DL-RSTD received from the PRU and the coordinates of the PRU, the downlink RTD being associated with a baseband symbol boundary difference in transmission between the first TRP and the second TRP and a difference between a transmission group delay at the first TRP and a transmission group delay at the second TRP.

19. The method of claim 18, further comprising, sending the downlink RTD to one or more other UEs through the base station.

20. The method of claim 18, further comprising,
receiving statistics of a difference between the reception group delay at the first pair of TX and RX RF chains and the reception group delay at the second pair of TX and RX RF chains of each of one or more other UEs.

21.-23. (canceled)
